(19) United States
(12) Patent Application Publication
(10) Pub. No.: US 2006/0230161 A1
(43) Pub. Date: Oct. 12, 2006

(54) System and method for providing service in a communication system

(75) Inventors: Su-Jin Bae, Suwon-si (KR); Jin-Suk Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/402,684

(22) Filed: Apr. 12, 2006

(30) Foreign Application Priority Data
Apr. 12, 2005 (KR) 30527-2005

(51) Int. Cl. G06F 15/16

(52) U.S. Cl. 709/228

(57) ABSTRACT

A system and method for providing a service in a user-selected communication mode in an IP multimedia communication system are provided. In a method of providing a service between a calling terminal and a called terminal in a communication system including a plurality of calling and called terminals and a network server, the calling terminal transmits a request message containing predetermined information for a call connection to the called terminal. The called terminal analyzes the information of the request message and transmitting a response message containing accept information for the request message to the calling terminal. The calling and called terminals perform bi-directional communications by changing a current communication mode in response to the response message.

### PRIORITY

This application claims priority under 35 U.S.C. § 119 to an application entitled “System and Method for Providing Service in a Communication System” filed in the Korean Intellectual Property Office on Apr. 12, 2005 and assigned Serial No. 2005-30527, the contents of which are incorporated herein by reference.

### BACKGROUND OF THE INVENTION

1. Field of the Invention

The present invention relates generally to a system and method for providing a service in a communication system, and in particular, to a system and method for enabling communications in a user-selected communication mode in an Internet Protocol (IP) multimedia communication system.

2. Description of the Related Art

While a 2^{nd} or 2.5^{th} generation Code Division Multiple Access (CDMA) wireless network provides voice service, the demand for high-speed multimedia service beyond the voice service is increasing in an existing 3^{rd} generation wireless network. A next generation communication network is migrating toward A11-IP which is a packet-based integrated network. Many scenarios of providing high-speed Internet and multimedia service possible in a legacy wired network to wireless terminals over the wired/wireless integrated network will become viable.

The focus of the Internet is shifting from data traffic such as the Web to real-time traffic such as remote education and remote conference. With the introduction of applications requiring real-time traffic delivery, the Internet itself is being developed to accommodate real-time traffic such as voice or images.

This change affects even network configuration. For example, a public network is evolving from a circuit-switched network to a packet-switched network and a Public Switched Telephone Network (PSTN) is being integrated into an IP network. The network integration allows for transmission of voice and fax over an IP network like the Internet. Along with this trend, Internet telephony service has emerged as a new Internet service.

The Internet telephony standardization organization, International Telecommunication Union-Telecommunication Standardization Sector (ITU-T) has adopted H.323 as an Internet telephony standard, and the Internet Engineering Task Force (IETF) Multiparty Multimedia Session Control (MMUSIC) working group has developed the Session Initiation Protocol (SIP) and adopted it as an interactive Internet service standard. SIP, which was proposed in March, 1993 by the IETF MMUSIC working group, is defined in Request For Comments (RFC) 3261.

H.323 (formally entitled “Packet-based Multimedia Communications Systems”) is an ITU standard recommendation for video conferencing over a packet-switched network represented by the Internet. Since H.323 itself is beyond the scope of the present invention, its description is not provided herein.

SIP is an application-layer control protocol developed to establish, modify, and terminate multimedia sessions (video and audio) or Internet telephony calls. SIP is part of an entire framework that the IETF MMUSIC working group has built for implementation of a multimedia multiparty communications system, together with Session Description Protocol (SDP: IETF RFC 2327), Session Announcement Protocol (SAP: IETF RFC 2974), Real-Time Stream Protocol (RTSP: IETF RFC 2326), and Simple Conference Control Protocol (SCCP). SIP is a client-server protocol residing above the UDP/TCP/IP layer, which transmits/receives SIP Request/Response messages in a request-response format and supports both unicast and multicast sessions so that a session can be initiated by invitation to a multimedia conference.

RFC 3261 (for SIP) defines six SIP Request methods: INVITE (invite the callee into a session), ACK (confirm a successful response for an INVITE request), BYE (terminate a call), REGISTER (register the user agent in the database of a redirect server), CANCEL (cancel a pending request), and OPTIONS (query the capabilities of the server). A SIP Response message includes a status code, which is set to 1xx (Information Response), 2xx (Successful Response), 3xx (Redirection Response), 4xx (Client Error, Request Failure), 5xx (Server Failure), or 6xx (Global Failure). SIP typically connects a call between SIP terminals over the Internet via a server.

FIG. 1 illustrates the configuration of a typical SIP system.

Referring to FIG. 1, the SIP system includes a SIP User Agent (UA) and SIP servers. The SIP UA contains two components, a User Agent Client (UAC) 110 and a User Agent Server (UAS) 170. The SIP servers include SIP proxy servers 120, 140 and 160, a redirect server 130, a location server 150, and SIP gateways (a SIP/H.323 gateway and a SIP/PSTN gateway).

The UAC 110 is a client application responsible for initiating calls by sending requests and the UAS 170 is a server application responsible for answering these calls by receiving requests and sending responses that accept, reject, or redirect the requests to a changed recipient address. This end terminal must implement these two functions, and the UA is a SIP application containing both the UAC and the UAS.

A SIP server is a server application for receiving requests and responses from the UA. There are three different SIP servers: a proxy server, a redirect server, and a location server.

The proxy servers 120, 140 and 160 respond to SIP requests or forward them to the next-hop server. The proxy server 140 forwards a SIP request based on information used for determining the next-hop server, received from the location server 150.

A proxy server can be either stateless or stateful according to its operation. A stateless proxy server forgets all information about a SIP request or response once it has been forwarded. Therefore, the stateless proxy server operates only based on a current SIP Request. Since any information about a SIP request is not stored, the stateless proxy server does not retransmit a message. A stateful proxy server remembers information concerning each incoming message and uses the information for future processing. When receiving a SIP request, a proxy server may get a plurality of transmission paths from the location server and thus forward the SIP request to a plurality of locations at the same time. This is called “forking”. The proxy server can operate as stateless or stateful according to a given situation. For forking or transmission by the Transport Control Protocol (TCP), the proxy server must operate as a stateful proxy.

The redirect server 130, when receiving an INVITE message for inviting the other party to a session, returns the address of the recipient received from the location server 150 to the UAC 110 by a “302 Moved Temporarily” response, instead of forwarding the SITE message to the next-hop server, so that the UAC 110 can invite the other party to the session by directly transmitting the INVITE message to the other party.

If users want to communicate by SIP, they register their locations to the location server 150 by a REGISTER message. A server application that receives the REGISTER message is called a registration server or a registrar. Servers which do not support the location registration functionality reply to the REGISTER message with a “501 Not Implemented” response.

The SIP gateways are required to connect a SIP network to a network using another signaling protocol, such as a PSTN or H.323 network which interworks with a SIP network. They include a SIP/PSTN gateway and a SIP/H.323 gateway. A description will now be made of the structure of the INVITE message in the SIP system.

FIG. 2 illustrates an example INVITE message in a typical SIP.

Referring to FIG. 2, the INVITE message includes a start line 210, a general header 215, a request header 220, an entity header 225, an empty line 230, and a message body 235. The start line 210 indicates the start of the INVITE message. The general header 215 applies to both request and response messages. In the general header 215, “Via” indicates the path taken by the request so far and also specifies the path that should be followed in routing a response, “To” specifies the recipient of the request, and “From” specifies the initiator of the request initiator. “Call-ID” uniquely identifies a particular invitation or all registrations of a particular client, and “CSeq” (Command Sequence) uniquely identifies a request within a Call-ID

The request header 220 describes the usage of the request. The entity header 225 indicates the type and length of the message body. The empty line 230 acts to indicate the remainder of the capacity of the INVITE message except for the capacity taken to express the information in the SIP. The message body 235 contains a description of information required for a call. A SIP call setup procedure in the SIP system will be described below.

FIG. 3 is a diagram illustrating a signal flow for a typical SIP call setup procedure.

Referring to FIG. 3, the SIP system includes a UAC 310 as a caller, a server 330, and a UAS 350 as a callee. The UAC 310 requests a call setup to the server 330 to connect a voice call to the UAS 350. Upon receipt of the call connection request, the server 330 locates the UAS 350 and forwards the call connection request to the UAS 350. The UAS 350 then transmits a return signal for the call connection request and establishes the call connection with the UAC 310.

The term “UA” used herein refers to a device for establishing a media session with another UA and terminates the media session, upon predetermined user input. “Session” means an activated connection between a user and a computer, or between two computers, that is, a connection between two terminals for communication.

In operation, the UAC 310 transmits an INVITE message to the server 330 in step 301. The server 330 analyzes the INVITE message and forwards the INVITE message to the UAS 350 in step 303. In step 305, the UAS 350 replies to the server 330 with a 180 RINGING signal indicating reception of the IVITE message. The server 330 forwards the 180 RINGING signal to the UAC 310 in step 307 and the UAS 350 transmits a 200 OK message to the server 330, notifying the server 330 that the invitation to a call session is accepted in step 309. In step 311, the server 220 forwards the 2000K message to the UAC 310.

The UAC 310 transmits an ACK message as a final confirmation for the 200 OK message to the UAS 350 in step 313. Thus, the call is established between the UAC 310 and the UAS 350 in step 315. With the call connected, the UAS 350 transmits a BYE message to the UAC 310 to terminate the call in step 317. The UAC 310 then transmits a 200 OK message indicating reception of the BYE message to the UAS 350 and terminates the call in step 319.

The SIP system using the above-described signaling supports various SIP-based Internet application services including Voice over IP (VoIP), Internet telephony service, multimedia video conferencing, instant messaging service, IMT-2000 wireless moving picture service, and web call center.

As described above, a caller attempts a call by dialing the phone number of a callee and the callee is alerted to the call by ringing in the SIP-based multimedia system. Conventionally, there is no specified function to change the communication mode of an incoming call. Therefore, the callee hears the ringing sound even when he doesn't want to. This service mechanism allows incoming of a call even if the callee is placed in a situation where he cannot answer the call, such as during a conference. Therefore, a ringing sound or vibrations created irrespective of a given situation can disturb the callee. Accordingly, there exists a need for receiving an incoming call in a changed communication method by a callee, that is, a service for enabling the callee to change the communication mode and conduct bi-directional communications in the changed communication mode, when he cannot answer an incoming call.

### SUMMARY OF THE INVENTION

An object of the present invention is to substantially solve at least the above problems and/or disadvantages and to provide at least the advantages below. Accordingly, the present invention provides a system and method for selectively changing the communication mode of a SIP multimedia terminal in an IP multimedia communication system.

The present invention provides a system and method for setting up a call between SIP terminals so that a bi-directional multimedia service is provided between the SIP terminals.

The present invention provides a system and method for attempting a call to a callee in polite mode and enabling the callee to converse with a caller in a white board mode by the callee's selection in an IP multimedia communication system.

The present invention provides a system and method for automatically changing the communication mode of an incoming call for which an alerting mode has been set to bell or vibration to a white board mode when a callee is in a situation where voice communication is not available or in any other specific situation, so that the callee's conversation is written in text by the text recognition function of a terminal, for bi-directional communications between a caller and the callee.

According to one aspect of the present invention, in a method of providing a service between a calling terminal and a called terminal in a communication system including a plurality of calling and called terminals and a network server, the calling terminal transmits a request message containing predetermined information for a call connection to the called terminal. The called terminal analyzes the information of the request message and transmits a response message containing accept information for the request message to the calling terminal. The calling and called terminals perform bidirectional communications by changing a current communication mode in response to the response message.

According to another aspect of the present invention, in a method of providing a service between a calling terminal and a called terminal in a communication system including the calling and called terminals and a network server, the calling terminal changes a current communication mode to a first communication mode before attempting a call, adds input data to a header and a body of a SIP request message, and transmits the SIP request message to the network server. The network server checks a service profile of the calling terminal, and forwards the SIP request message to the called terminal, if the calling terminal supports the first communication mode. The called terminal analyzes header information included in the SIP request message, determines a communication mode for connection to the calling terminal, and when recognizing that the calling terminal supports the first communication mode, adds information corresponding to the determined communication mode to a response message, and transmits the response message. The network server receives the response message from the called terminal, checks a service profile of the called terminal, forwards the response message to the calling terminal, if the called terminal supports a second communication mode, and establishes an RTP connection between the calling and called terminals. The calling terminal checks the connection communication mode of the called terminal from the response message, changes the communication mode to the second communication mode if the connection communication mode is the second communication mode, and directly transmits an accept message corresponding to the communication mode change to the called terminal. The calling and called terminals provide a service in the second communication mode, after the call connection.

According to a further aspect of the present invention, in a system for providing a service between a calling terminal and a called terminal in a communication system including a plurality of calling and called terminals and a network server, terminals transmit and receive predetermined multimedia data by a SIP and perform bi-directional communication by a white board. At least one network server processes a session between the terminals and determines validity for polite mode and white board mode communications.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the configuration of a typical SIP-based system;

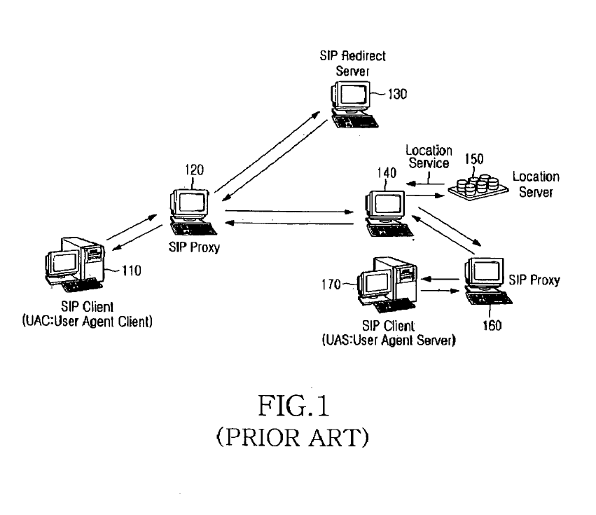

FIG. 2 illustrates an exemplary structure of an INVITE message based on the SIP;

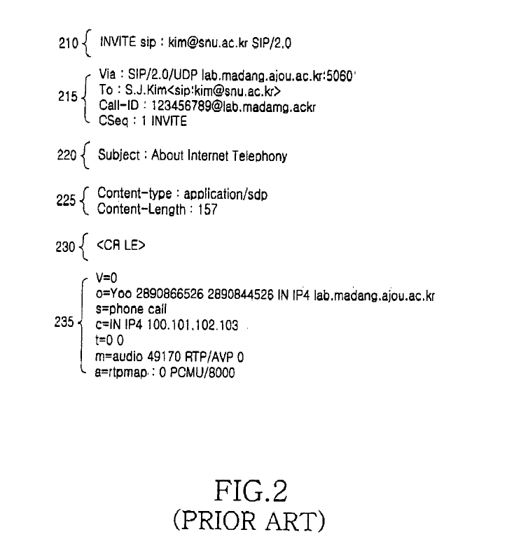

FIG. 3 is a diagram illustrating a signal flow for a basic SIP call setup procedure;

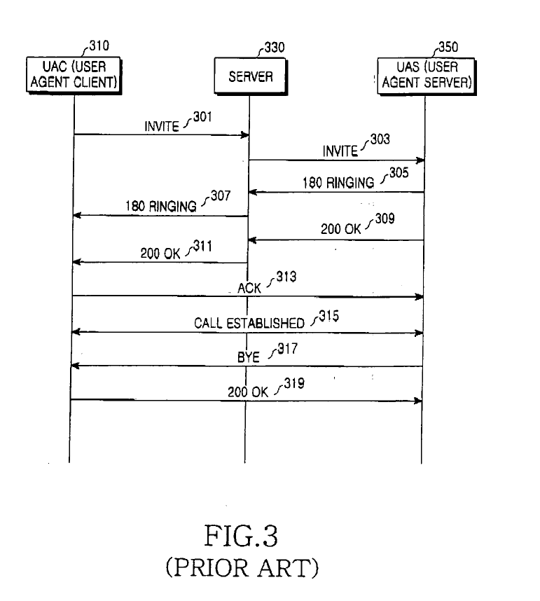

FIG. 4 illustrates the configuration of a system for implementing the present invention; and

FIG. 5 is a diagram illustrating a signal flow for a polite mode and white board mode call setup procedure according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

In accordance with the present invention, “polite mode service” is a service of providing a callee with a multimedia message including a text message, a recorded voice, and an image of a caller, together with ring tones. In addition, it can be requested that the alerting mode of the callee's terminal be changed from bell to vibration.

“White board mode service” is a service that enables communications through a white board, instead of voice communications, if the callee cannot conduct a voice call, for example, in a conference or in any other situation when he cannot be audibly alerted of an incoming call. For communications through a white board, the callee changes the communication mode of the incoming call for which an alerting mode has been set to bell or vibration to white board mode and writes his speech by the text recognition function of his terminal. In this way, bi-directional communications are conducted between the caller and the callee.

The present invention is directed to a system and method for providing a service to a user in a communication system. When the caller attempts a call, the intention or purpose, and identification of the caller is transmitted along with the call. When the callee cannot answer the call, he checks the caller information before ring tones or vibrations are created. If he wants to converse with the caller, the callee changes the communication mode, for bi-directional communications in accordance with the present invention.

The present invention is also intended to provide a system and method for providing mobile multimedia service in a communication system. In the present invention, a call is set up between SIP terminals, for bi-directional multimedia service. To be more specific, the caller attempts a call in polite mode and the callee can communicate with the caller in white board mode by his selection in an IP multimedia communication system. The white board mode is an option that is controllable by the callee. While the present invention is described in the context of the IP multimedia communication system, it is applicable to other communication systems.

In accordance with the present invention, when the caller attempts a call, he provides the callee with a message and image of the caller according to his preferences or options before ring tones are created. The alerting mode of the callee's terminal is changed, for example, from bell to vibration. This is polite mode service. If the callee cannot conduct voice communications or in any other specific case, the communication mode of the incoming call for which an alerting mode has been set to bell or vibration is automatically changed to white board mode so that the callee writes his speech by the text recognition function of his terminal, for bi-directional communications between the caller and the callee.

To serve the above-described purposes, a differentiated call model is provided by presenting terminal requirements, a SIP message from a caller, a transmission scheme for, for example, pictures, white board mode transition function, and additional service features that can be offered by the function.

For alerting the callee in the above alternatives, the following requirements are assumed.

Terminal Requirements

1) Function of transmitting a text message or image of the caller at call origination to the callee on a signaling channel, for example, by a SIP_INVITE method, for communications in polite mode.

2) Text input and recognition function for communications in white board mode.

3) Function of displaying a text message or image of the caller included in a SIP message on the callee's terminal.

4) Add an option button to select polite mode or white board mode.

IP Multimedia Subsystem (IMS) Server Requirements

1) Function of setting up a session for an IP multimedia subscriber.

2) Control function of communications in polite mode and white board mode according to subscriber profile.

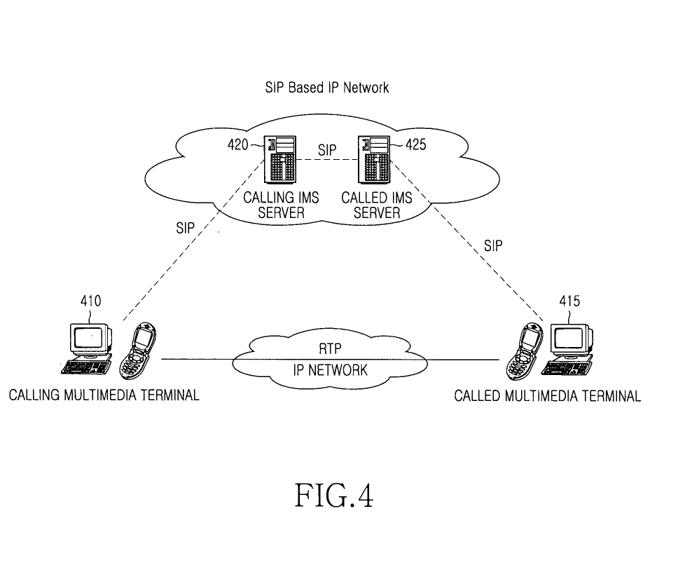

FIG. 4 illustrates the configuration of a system for implementing the present invention.

Referring to FIG. 4, the system includes IP multimedia terminals 410 and 415 for transmitting a text message or image of a caller according to his preferences at a call attempt and performing white board mode communications, and IMS servers 420 and 425 serving as call servers for processing sessions.

The multimedia terminals 410 and 415 can be wired, wireless or wired-wireless integrated terminals. They provide processing power sufficient for multimedia reproduction. The multimedia terminals 410 and 415 can transmit/receive and display messages like text and pictures by SIP messages.

The IMS servers 420 and 425 are responsible for call setup and call release between the multimedia terminals 410 and 415, that is, between a calling multimedia terminal 410 and a called multimedia terminal 415. The IMS servers 420 and 425 determine validity for the polite mode or white board mode service according to the service profiles of the caller and the callee. For a subscriber valid for the polite mode or white mode service, they set up a call, and otherwise they process the basic call without polite mode or white mode service.

Now a detailed description will be made of the polite mode service and the white board mode service according to the present invention.

Before attempting a call, the caller presses a predetermined button associated with polite mode and enters an intended text message, records a voice message, or selects multimedia data like an image. Then the caller dials a callee by entering his phone number or selecting a present callee in addressbook. At the call attempt, the message and multimedia data such as an image are included in the Content-Type Header and the Message Body of a SIP_INVITE message. And the caller can add “polite-wb-v1.0” to a User-Agent Header, notifying that the caller's terminal is a multimedia terminal supporting polite/white board mode. Media Type is set for Voice Streaming and White Board in an SDP part as well as caller information required for the polite mode communications is set in the Message Body.

For example, the SIP message may have the following configuration. In this embodiment of the present invention, it is assumed that a text message and an image are transmitted together.

### Embodiment

INVITE sip:someone@samsung.com SIP/2.0

Via:SIP/2.0/UDP example.com;branch=z9hG4bKffe209934aac

To: sip:someone@samsung.com

From: <sip:vivien74@samsung.com>;tag=2909034023

Call-ID: fe9023940-a3465

CSeq: 127 INVITE

Max-Forwards: 70

User-Agent: polite-wb-v1.0

## Description: the User-Agent header field contains information about the features, name or version of the UAC originating the request polite-wb-v1.0 is set in the User-Agent header field to indicate that the UAC supports polite/white board mode. For example, if the UAC supports Push to talk on Cellular (PoC), the User-Agent header field is set to Poc-Client/OMA1.0.

Contact: <sip:vivien74@sec.samsung.com>

Content-Type: multipart/mixed; boundary=unique-boundary-1

## Description: the Content-Type header field is set to multipart so that one or more multimedia messages can be transmitted. A content type is inserted under a boundary identifier, “unique-boundary-l” in the following SIP message body.

Content-Length:

## Description: the following is shown in the SIP message body.

—unique-boundary-1

Content-Type: multipart/parallel;boundary=unique-boundary-2

—unique-boundary-2

Content-Type: text/plain

Content-Disposition: inline

Content-Description: text-part-1

[Some Text Goes Here]

## Description: base64-encoded 8000 Hz signal-channel mu-law-format audio data goes here. That is, the voice recorded by the caller is defined by the Content-Type and embedded in the body after encoding.

—unique-boundary-2

Content-Type: image/jpeg

Content-Disposition: Attachment

Content-Transfer-Encoding: base64

Content-Description: Picture A

[Encoded jpec Image]

## Description: base64-encoded image data goes here. That is, the image of the caller can be transmitted together with the text message, after encoding.

—unique-boundary-2

Content-Type: multipart/mixed; boundary=unique-boundary-3

## Description: the Content-Type header field is set to multipart so that one or more multimedia messages can be transmitted. A content type is inserted under a boundary identifier, “unique-boundary-3” in the following message body. Information is inserted in SDP to support polite/white board mode. The UAC originating the request explicitly indicates in the SDP that it supports a PCMU/PCMA/iLBC.G726-23/GSM voice codec and the user-defined application supports white board mode.

Content-Type: application/SDP

v=0

o=polite-wb-v1.0 194839284 42384923 IN IP4 vivien74@samsung.com

c=In IP4 vivien74@samsung.com

t=0 0

m=audio 30000 RTP/AVP 0 8 97 2 3

a=rtpmap:0 PCMU/8000

a=rtpmap:8 PCMA/8000

a=rtpmap:97 iLBC/8000

a=rtpmap:2 G726-32/8000

a=rtpmap:3 GSM/8000

m=x-application 32416 udp wb

m=video 49232 RTP/AVP 98

a=rtpmap:98 L16/16000/2

a=sendrecv

##Description: the SIP message body is given as follows.

—unique-boundary-3

The calling and called IMS servers check subscriber service profiles and, if the terminals are authorized for polite mode communications, continue the call setup. If the User-Agent Header is set to polite-wb-v1.0 in the received INVITE message, the called terminal recognizes that the calling terminal supports polite/white board mode and reads the remaining part of the message body except the SDP body part. Then it visually or audibly outputs the text/image/sound according to the Content-Type.

The callee connects the voice call by directly transmitting Call Accept to the caller according to the information sent to the callee based on the Content-Type or the current status, or transmits a 200 OK message to the caller, including preference of white board mode. There is no additional message indicating to the caller that the callee has selected Call Accept or White Board, but the callee defines Media Type in the SDP added to the message body of the 200 OK message to indicate the white board mode transition. The caller determines whether to establish a Real Time Protocol (RTP) connection for voice streaming or a white board connection (an RTP with UDP/TCP or a separately procured connection for a white board protocol) and attempts a connection according to the determination. The caller can attempt the two connections at the same time. A SIP message for this case is given as follows according to an embodiment of the present invention.

### Embodiment

SIP/2.0 200 OK

Via: SEP/2.0/UDP example.com;branch=z9hG4bKffe209934aac

To: sip:someone@samsung.com

From: <sip:vivien74@samsung.com>;tag=2909034023

Call-ID: fe9023940-a3465

CSeq: 127 INVITE

Max-Forwards: 70

User-Agent: polite-wb-v1.0

Contact: <sip :vivien74@sec. samsung.com>

Allow: INVITE,ACK,CANCEL,BYE,REFER,OPTIONS,NOTIFY,INFO

Content-Type:application/SDP

Content-Length:258

v=0

o=Wibro-polite-wb-v1.0 0 0 In IP4 someone@samsung.com

s=call-polite-wb

c=IN IP4 someone@samsung.com

t=0 0

m=audio 1000 RTP/AVP 8

a=rtpmap:8 PCMA/8000

## Description: for voice streaming, the two lines (m=audio 1000 RTP/AVP 8, a=rtpmap:8 PCMA/8000) must be alternative set. If the callee can answer the incoming call and accepts it, this is indicated to the caller by a 200 OK message. On the other hand, if the callee cannot answer the incoming call and thus transitions to the white board mode by selecting a white board mode button, the two lines are deleted and White Board is alternative set in the following Media Type header (m=x-application 50000 udp wb). Hence, only White Board, not the voice call is connected so that the speech of the callee is transmitted to the caller through White Board. If the Media Type is transmitted at the same time, voice streaming and White Board are simultaneously connected so that White Board can be used simultaneously with the voice call.

m=x-application 50000 udp wb

## Description: the caller responds that he uses White Board.

x-application (user-defined application, x—is deleted in the case of well-known application)

50000: use Port #50000

udp: use UDP

wb: it indicates that white board mode is used among user-defined applications. For White Board, an existing standard protocol or a protocol used in NetMeeting of MS-windows is adopted. Or a new user-defined protocol is available.

After subscriber service profiles, if the subscribers are authorized for white board mode communications, the calling and called IMS servers transmit messages to the calling terminal by continuing on-going processing. Upon receipt of a request of changing to direct white board mode, the calling terminal notifies the caller of the mode change by text or tones. The caller presses a specific button associated with direct white board communications and transmits an accept message, for example, SIP_UPDATE message method to the called terminal.

The callee then writes text in his terminal that has changed to the white board mode and transmits the text to the caller. Thus, white board mode communications are conducted between the caller and the callee by an RTP bearer.

A procedure for set up of a call between a caller and a callee in polite/white board mode will be described below.

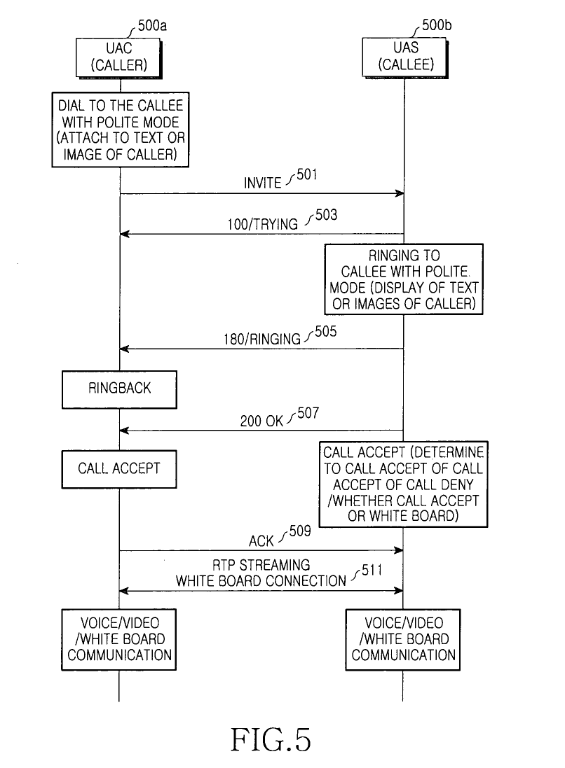

FIG. 5 is a diagram illustrating a signal flow for a polite mode and white board mode call setup procedure according to the present invention.

Referring to FIG. 5, a SIP system according to the present invention includes a UAC 500a being a calling terminal and a UAS 500b being a called terminal. For notational simplicity, signal transmission and reception between UAC 500a and UAS 500b and IMS servers that relay a call for UAC 500a and UAS 50b will not be described herein.

Referring to FIG. 5, when attempting a call, the UAC 500a transmits caller information necessary for polite mode, that is, multimedia data such as a message and an image of the caller in the body of a SIP_INVITE message to the UAS 500b in step 501. The UAS 500b determines whether the INVITE message includes polite-wb-v1.0 in a User-Agent header field. In the absence of polite-wb-v1.0, 100 Trying and 180 Ringing response messages indicating a general call attempt are exchanged between the UAS 500b and the UAC 500a in steps 503 and 505. Thus, a voice/video connection is established between the UAC 500a and the UAS 500b. On the other hand, in the presence of polite-wb-v.1.0 in the INVITE message, the UAS 500b recognizes that the UAC 500a supports polite/white board mode, reads the remaining part of the message body except for the SDP body part, and visually or audibly outputs received text/image/sound to the callee according to the Content-Type.

Upon user request for transition to polite/white board mode, the UAS 500b transitions to white board mode and transmits a 200 OK message to the UAC 500a, notifying the UAC 500a that the invitation to the session is accepted in step 507. As described above, whether the callee has selected Call Accept or White Board is notified to the caller by Media Type in SDP added to the message body of the 200 OK message.

In accordance with the caller's request, the UAC 500a determines whether to establish an RTP connection for voice streaming or a white board connection (RTP with UDP/TCP or a separately procured connection for a white board protocol) according to the Media Type of the SDP and then attempts a call connection to the UAS 500b by transmitting an ACK message according to the determination in step 509. Notably, the RTP connection and the white board connection can be established simultaneously. The format of a SIP message for this case has been described earlier. By this SIP message, the RTP connection and the white board connection are simultaneously established between the UAC 500a and the UAS 500b in step 511.

Meanwhile, upon receipt of a request for changing to a direct white board from the UAS 500b, the UAC 500a notifies the caller of the mode transition by text or by tones. Then, upon receipt of a command signal accepting the mode transition from the caller, the UAC 500a transmits an accept message, for example, a SIP_UPDATE message to the UAS 500b. Finally, when the UAS 500b transitions to white board mode, communications are conducted between the UAC 500a and the UAS 500b by an RTP bearer.

As described above, the present invention advantageously offers differentiation, diversity, and personalization to a communication system by providing a polite mode service for a caller and a direct white board function for a callee. In addition, the callee can find caller information and the purpose of a call connection from the caller before he is alerted to the incoming call and easily handle a situation where accepting a voice call is not convenient. Since a text message and multimedia data of the caller can be provided to the callee, personal services can be differentiated. Furthermore, even in a situation where a voice call is not available, transition to a different communication mode such as white board mode provides a new conmmunication opportunity and convenience to the callee. Also, service providers may create diverse profit structures by differentiating their systems from legacy systems.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of providing a service between a calling terminal and a called terminal in a communication system including a plurality of calling and called terminals and a network server, comprising the steps of:
transmitting a request message containing predetermined information for a call connection to the called terminal by the calling terminal;
analyzing the information of the request message and transmitting a response message containing accept information for the request message to the calling terminal by the called terminal; and
performing bi-directional communications by changing a current communication mode in response to the response message by the calling and called terminals.

2. The method of claim 1, wherein the predetermined information contains information about the purpose of a call attempt from the calling terminal and caller information.

3. The method of claim 1, wherein the request message is a session initiation protocol message containing multimedia data with a text message and an image in a header and a body.

4. The method of claim 3, wherein the request message further includes information indicating that the calling terminal has a communication mode change function in the header.

5. The method of claim 3, wherein the request message further includes caller information and media type information of the calling terminal in the body.

6. The method of claim 1, wherein the response message includes information about a voice communication mode or a bi-directional communication mode of the called terminal.

7. The method of claim 1, wherein the called terminal displays the request message before an alerting mode is activated for an incoming call.

8. The method of claim 1, wherein the bi-directional communications are real-time communications of voice, an image, audio, and a message according to agreement between the calling and called terminals.

9. The method of claim 1, wherein the calling and called terminals perform voice over internet protocol service by the session initiation protocol.

10. The method of claim 1, wherein the calling and called terminals transmit and receive an encoded input text message or an encoded predetermined image on a signaling channel.

11. The method of claim 1, wherein the calling and called terminals have a text input function and a text recognition function and transmit recognized text over an internet protocol network by a real time protocol bearer.

12. The method of claim 1, further comprising the step of decoding received multimedia data and displaying the decoded multimedia data by the calling and called terminals.

13. A method of providing a service between a calling terminal and a called terminal in a communication system including the calling and called terminals and a network server, comprising the steps of:
changing a current communication mode to a first communication mode before attempting a call, adding input data to a header and a body of a session initiation protocol request message, and transmitting the session initiation protocol request message to the network server by the calling terminal;
receiving the session initiation protocol request message from the calling terminal, checking a service profile of the calling terminal, and forwarding the session initiation protocol request message to the called terminal by the network server, if the calling terminal supports the first communication mode;
receiving the session initiation protocol request message from the network server, analyzing header information included in the session initiation protocol request message, determining a communication mode for connection to the calling terminal, when recognizing that the calling terminal supports the first communication mode, adding information corresponding to the determined communication mode to a response message, and transmitting the response message by the called terminal;
receiving the response message from the called terminal, checking a service profile of the called terminal, forwarding the response message to the calling terminal, if the called terminal supports a second communication mode, and establishing a real time protocol connection between the calling and called terminals by the network server;
receiving the response message from the network server, checking the connection communication mode of the called terminal from the response message, changing the communication mode to the second communication mode if the connection communication mode is the second communication mode, and directly transmitting an accept message corresponding to the communication mode change to the called terminal by the calling terminal; and
providing a service in the second communication mode, after the call connection, by the calling and called terminals.

14. The method of claim 13, wherein the first communication mode is a polite mode in which multimedia data of a caller is provided to a callee, together with ring tones.

15. The method of claim 14, wherein the step of providing multimedia data from the caller to the callee further comprises the step of requesting an alerting mode of the called terminal from ring tones to vibration.

16. The method of claim 13, wherein if the caller cannot conduct voice communications, the second communication mode is a white board mode in which communications are performed through a white board, not by voice.

17. The method of claim 16, comprising the step of performing bi-directional communications between the calling and the called terminals by a text recognition function, after changing to the white board mode.

18. The method of claim 13, further comprising the step of selecting whether to provide the first and second communication mode service according to the service profiles of the calling and called terminals.

19. The method of claim 13, further comprising the step of determining whether to accept or reject the requested first and second communication mode connections according to the type of the other terminal by the calling and called terminals.

20. The method of claim 13, further comprising the step of selecting and changing multimedia data transmitted in the first and second communication modes according to the type of the other terminal by the calling and called terminals.

21. The method of claim 13, further comprising the step of reading a body of the SIP request message, when recognizing that the calling terminal supports the first communication mode, and displaying multimedia data included in the body.

22. A system for providing a service between a calling terminal and a called terminal in a communication system including a plurality of calling and called terminals and a network server, comprising:
terminals for transmitting and receiving predetermined multimedia data by a session initiation protocol and performing bi-directional communications by a white board; and
a network server for processing a session between the terminals and determining validity for a polite mode and a white board mode communications.

23. The system of claim 22, wherein when the terminals transmit and receive the multimedia data in the polite mode by the SIP, the alerting mode of the called terminal is changed from ring tones to vibration.

24. The system of claim 22, wherein when a callee cannot conduct voice communications, the terminals change to the white board mode and perform bi-directional communications by a text recognition function in the white board mode.

25. The system of claim 22, wherein the at least one network server determines whether to provide the polite mode and white board mode service according to service profiles of the calling and called terminals.
